(19) United States
(12) Patent Application Publication
(10) Pub. No.: US 2012/0134105 A1
(43) Pub. Date: May 31, 2012

(54) DATA CENTER

(75) Inventor: YAO-TING CHANG, Tu-Cheng (TW)

(73) Assignee: HON HAI PRECISION INDUSTRY CO., LTD., Tu-Cheng (TW)

(21) Appl. No.: 12/955,909

(22) Filed: Nov. 30, 2010

(30) Foreign Application Priority Data
Nov. 25, 2010 (TW) 99140685

(51) Int. Cl. G06F 1/20

(52) U.S. Cl. 361/679.47

(57) ABSTRACT

A data center includes a housing, a number of server modules arranged in the housing, a number of cooling units arranged in the housing and above the server modules, a fan mounted in the housing near the cooling units, and a number of directing plates arranged in the housing and spaced from the inner surfaces of the housing. When the data center is operating, heated air from the server modules is driven into the apace between the inner surfaces of the housing and the directing plates and then to the cooling units by the fan, and then the cooled air is driven to enter the server modules.

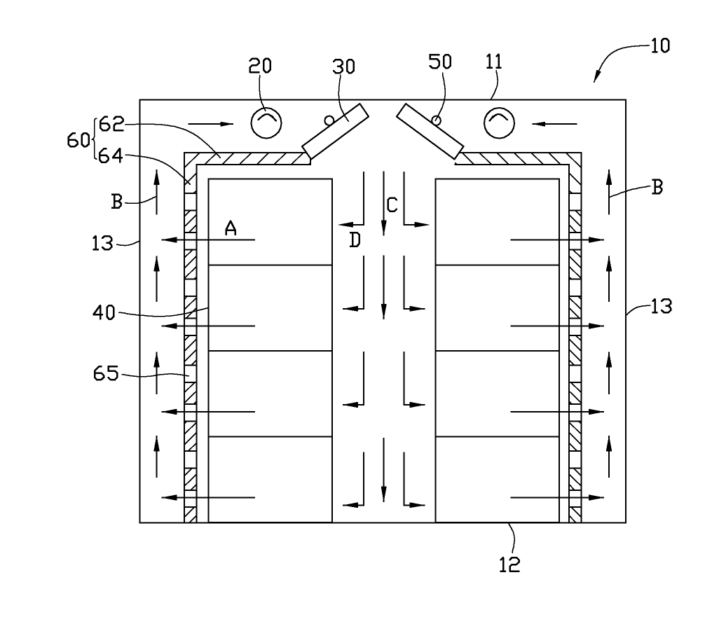

### BACKGROUND

1. Technical Field

The present disclosure relates to a data center.

2. Description of Related Art

A data centers usually includes a plurality of server modules arranged in a house of the data center. Although airflow is generated in the data center for heat dissipation, the air will become heated and re-circulated within the data center, thus reducing the effect of cooling.

### BRIEF DESCRIPTION OF THE DRAWING

Many aspects of the present embodiments can be better understood with reference to the following drawing. The components in the drawing are not necessarily drawn to scale, the emphasis instead being placed upon clearly illustrating the principles of the present embodiments. Moreover, in the drawings, all the views are schematic, and like reference numerals designate corresponding parts throughout the several views.

The FIGURE is a schematic view of an embodiment of a data center.

### DETAILED DESCRIPTION

The disclosure, including the accompanying drawing, is illustrated by way of examples and not by way of limitation. It should be noted that references to “an” or “one” embodiment in this disclosure are not necessarily to the same embodiment, and such references mean at least one.

Referring to the FIGURE, an exemplary embodiment of a data center includes a housing 10. The housing 10 includes a top wall 11, a bottom wall 12 opposite to the top wall 11, and opposite left and right sidewalls 13 connected between the top wall 11 and the bottom wall 12. Several server module assemblies are arranged in the housing 10 and spaced from each other. Each server module assembly includes a plurality of server modules 40 stacked upright in the housing 10. Airflow interspaces are arranged between each server module assembly and the left and right sidewalls 13 of the housing 10. Each server module 40 defines a plurality of through holes (not shown in FIGURE) respectively facing towards the left and right sidewalls 13 of the housing 10. Two cooling units 30, such as heat exchangers or water chillers, are arranged in the housing 10 near the top wall 11, respectively facing towards each server module assembly. The cooling units 30 are located above these server module assemblies, and incline outwardly.

Two fans 20 are arranged at opposite sides of the cooling units 30 above each server module assembly and near the corresponding cooling units 30. A plurality of directing plates 60 are arranged in the housing 10 and spaced from the inner surfaces of the housing 10. In this embodiment, the directing plates 60 include a plurality of top directing plates 62 arranged between the top wall 11 of the housing 10 and the server module assemblies, and a plurality of side directing plates 64 arranged between the left and right sidewalls 13 of the housing 10 and the corresponding server module assemblies. The top directing plates 62 are set below the cooling units 30 and the fans 20. The directing plates 60 may be made of metal material or acrylic material. A plurality of through holes 65 are defined in the side directing plates 64.

When the data center operates, heated air from the server module assembly flows out of the server modules 40 through the through holes of the server modules 40 along A direction, then flows through the through holes 65 of the side directing plates 64 toward the fans 20 along direction B, and is then driven to the corresponding cooling units 30 by the fans 20. The heated air is cooled by the cooling units 30. Cooled air goes down along direction C and enters the server modules 40 along direction D, to cool the server modules 40. As a result, in the present disclosure, heated air flows into the space between the left and right sidewalls 13 of the housing 10 and the side directing plates 64. The directing plates 60 can direct the heated air generated by the server modules 40 away from the server modules 40. Furthermore, the directing plates 60 also can direct air coming from outside of the housing 10 to be cooled.

Furthermore, a plurality of temperature sensing elements 50 can be arranged in the housing 10 adjacent to the fans 20, for sensing the temperature of the airflow near the fans 20, to control the rotation speeds of the fans 20.

It is to be understood, however, that even though numerous characteristics and advantages of the embodiments have been set forth in the foregoing description, together with details of the structure and function of the embodiments, the disclosure is illustrative only, and changes may be made in detail, especially in matters of shape, size, and arrangement of parts within the principles of the present disclosure to the full extent indicated by the broad general meaning of the terms in which the appended claims are expressed.

What is claimed is:

1. A data center comprising:
a housing comprising a top wall, a bottom wall opposite to the top wall, and opposite left and right sidewalls;
a plurality of server modules arranged in the housing;
a plurality of cooling units arranged in the housing near the top wall and above the server modules;
a plurality of fans arranged in the housing, adjacent to the cooling units; and
a plurality of directing plates arranged in the housing and spaced from the inner surfaces of the housing, the directing plates comprising a plurality of top directing plates arranged between the top wall of the housing and the top server modules and a plurality of side directing plates arranged between the left and right sidewalls of the housing and the server modules, wherein the top directing plates are set below the cooling units and the fans, a plurality of through holes are defined in the side directing plates;
wherein when the data center operates, heated air flows out of the plurality of server modules, and then flows through the through holes of the side directing plates toward the fans, and is then driven to the corresponding cooling units by the fans, the heated air is cooled by the cooling units, cooled air goes down and enters the server modules to cool the server modules.

2. The data center of claim 1, wherein the plurality of server modules are stacked upright in the housing, each cooling unit is located above the stacked server modules.

3. The data center of claim 1, wherein the directing plates is made of metal material or acrylic material.

4. The data center of claim 1, further comprising a plurality of temperature sensing elements arranged in the housing adjacent to the plurality of fans, for sensing the temperature of the airflow near the plurality of fans.

5. The data center of claim 1, wherein the plurality of cooling units are heat exchangers or water chillers.
